(19) United States
(12) Patent Application Publication
(10) Pub. No.: US 2016/0271840 A1
(43) Pub. Date: Sep. 22, 2016

(54) METHOD FOR MAKING A HEAT DISSIPATION ELEMENT

(71) Applicant: ADVANCED INTERNATIONAL MULTITECH CO., LTD., Kaohsiung City (TW)

(72) Inventors: Ching-Shan TSAI, Kaohsiung City (TW); Cetera CHEN, Kaohsiung City (TW); Chun-Yu CHANG, Kaohsiung City (TW)

(21) Appl. No.: 14/842,117

(22) Filed: Sep. 1, 2015

(30) Foreign Application Priority Data
Mar. 17, 2015 (TW) 104108484

(51) Int. Cl. B29C 41/00

(52) U.S. Cl. CPC B29C 41/003; B29K 2075/00

(57) ABSTRACT

A method of making a heat dissipation element includes the steps of: preparing a liquid matrix having a viscosity ranging from 1000 cps to 30000 cps; dipping a plurality of thermally conductive fibers into the liquid matrix and having the thermally conductive fibers partially exposed from the liquid matrix; and solidifying the liquid matrix into a support member from which the thermally conductive fibers are partially exposed.

### CROSS-REFERENCE TO RELATED APPLICATION

This application claims priority of Taiwanese Patent Application No. 104108484, filed on Mar. 17, 2015.

### FIELD

The disclosure relates to a method for making a heat dissipation element, more particularly to a method for making a heat dissipation element including a plurality of thermally conductive fibers.

### BACKGROUND

Heat dissipation has become one of the major concerns for electronic devices. For high power electronic devices, the lifetime thereof may decrease by 50% for each 10° C. increase of the operating temperature. Thus, electronic devices are often provided with heat dissipation elements (e.g., a heat sink, a heat dissipation fin, etc.) for dissipating heat generated thereby.

With the development of miniaturized and denser semiconductor devices, there is a need in the art to provide a heat dissipation element with superior heat dissipation efficiency.

### SUMMARY

Therefore, an object of the disclosure is to provide a method of making a heat dissipation element with improved heat dissipation capability.

According to an aspect of the present disclosure, a method of making a heat dissipation element includes:

preparing a liquid matrix having a viscosity ranging from 1000 cps to 30000 cps;

dipping a plurality of thermally conductive fibers into the liquid matrix and having the thermally conductive fibers partially exposed from the liquid matrix; and

solidifying the liquid matrix into a support member from which the thermally conductive fibers are partially exposed.

### BRIEF DESCRIPTION OF THE DRAWINGS

Other features and advantages of the present disclosure will become apparent in the following detailed description of the exemplary embodiment with reference to the accompanying drawings, of which:

FIG. 1 is a perspective view of an exemplary embodiment of a heat dissipation element according to the present disclosure; and

FIG. 2 is a flow chart of a method of making the embodiment.

### DETAILED DESCRIPTION

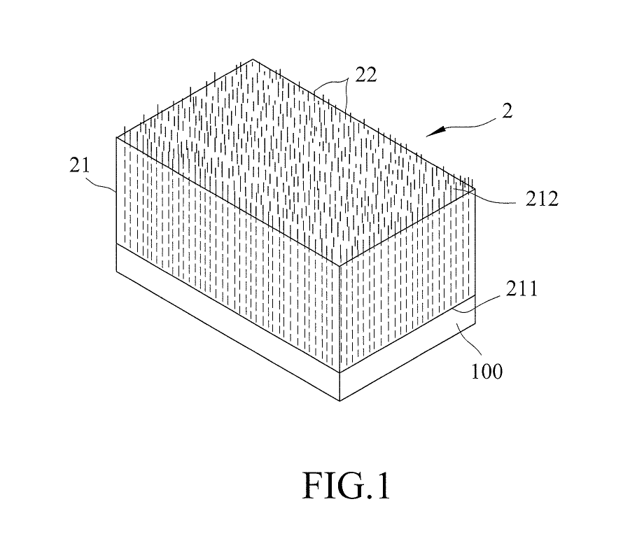

Referring to FIG. 1, an exemplary embodiment of a heat dissipation element 2 of the present disclosure is adapted to be connected to an electronic device 100 for dissipating heat generated by the electronic device 100. The heat dissipation element 2 includes a support member 21 and a plurality of thermally conductive fibers 22. The support member 21 has a bottom surface 211 that is in contact with the electronic device 100, and a top surface 212 spaced apart and opposite to the bottom surface 211. The support member 21 is made of a material selected from the group consisting of a metal material, an alloy material, and a polymer material. To be more specific, the support member 21 is made of a material selected from the group consisting of silver, aluminum, copper, zinc, antimony, an aluminum alloy, a phenol formaldehyde resin, an epoxy resin, a silicone resin, a polyurethane resin, and a furan resin.

The thermally conductive fibers 22 have a thermal conductivity ranging from 380 W/m·K to 2000 W/m·K, and are selected from the group consisting of metal fiber, carbon fiber, and the combination thereof. Specifically, the carbon fiber is a high thermal conductivity carbon fiber, e.g., a graphitized vapor grown carbon fiber. In one example, each of the thermally conductive fibers 22 has a predetermined length, and extends along a direction substantially perpendicular to the top surface 212 to be partially exposed from the base surface 212.

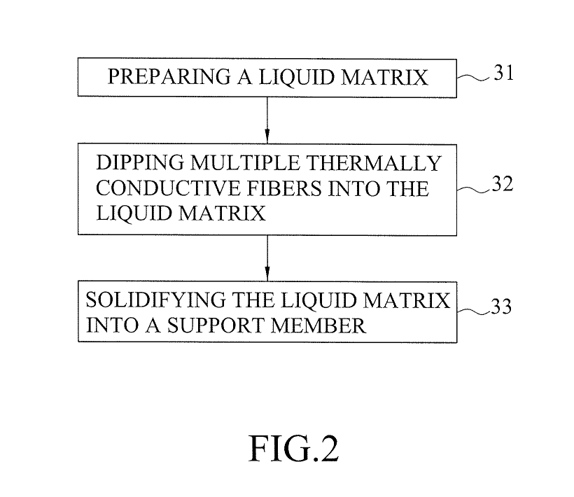

FIG. 2 illustrates a flowchart of a method for making the heat dissipation element 2. The method includes the following steps:

preparing a liquid matrix having a viscosity ranging from 1000 cps to 30000 cps;

dipping the thermally conductive fibers 22 into the liquid matrix and having the thermally conductive fibers 22 partially exposed from the liquid matrix; and

solidifying the liquid matrix into the support member 21 from which the thermally conductive fibers 22 are partially exposed.

The matrix is made of a composition including a base material selected from the group consisting of a polymer material, a metal material, and an alloy material. To be more specific, the base material may be, e.g., silver, aluminum, copper, zinc, antimony, an aluminum alloy, a phenol formaldehyde resin, an epoxy resin, a furan resin, a polyurethane resin, or a silicone resin.

It should be noted that the viscosity of the liquid matrix is desirably controlled within 1000 cps to 30000 cps. If the viscosity of the liquid matrix is too high, the thermally conductive fibers 22 may not be able to be dipped thereinto. If the viscosity of the liquid matrix is too low, due to capillary action, the liquid matrix may flow between the thermally conductive fibers 22 and be thus coated on the exposed thermally conductive fibers 22. Therefore, the composition of the matrix may further include a viscosity modifier for adjusting the viscosity of the liquid matrix.

The liquid matrix may be formed by heating or by dissolving the base material in the viscosity modifier.

The base material may be composed of various polymer materials with different viscosities for controlling the viscosity of the liquid matrix. Alternatively, a polymer material of the base material may be mixed with a viscosity modifier to form the liquid matrix with desired viscosity. The viscosity modifier may be capable of or incapable of reacting with the polymer material.

For example, when the base material of the matrix is the epoxy resin, the viscosity modifier may be one capable of reacting with the epoxy resin, e.g., n-butyl glycidyl ether, 1,4-butanediol diglycidyl ether, ethylene glycol diglycidyl ether, phenyl glycidyl ether, polypropylene glycol diglycidyl ether, C₁₂-C₁₄ aliphatic glycidyl ether, benzyl glycidyl ether, 1,6-hexanediol diglycidyl ether, o-cresyl glicidyl ether, and neopentyl glycol diglycidyl ether. Alternatively, the viscosity modifier may be one incapable of reacting with the epoxy resin, e.g., acetone, anhydrous ethanol, toluene, xylene, styrene, ethyl acetate, butyl acetate, dimethylformamide, benzyl alcohol, and polyol. When the base material is the metal material or the alloy material, the metal material or the alloy material is melted under heat to obtain the liquid matrix. Melting of the metal material or the alloy material is performed under an inert gas atmosphere, thereby preventing the matrix from oxidation.

In this embodiment, the base material is an epoxy resin (e.g., EPON™ Resin 828, which has a viscosity of 15000 cps in the liquid phase). The viscosity modifier is capable of reacting with the epoxy resin and is the C₁₂-C₁₄ aliphatic glycidyl ether. At room temperature (25° C.), the epoxy resin is dissolved in the viscosity modifier such that the matrix has a viscosity not greater than 2000 cps.

In the dipping step, the thermally conductive fibers 22 are gathered into a bundle. One end of the bundle is clamped by a fixture and the other end of the bundle is dipped into the liquid matrix. With consideration for operational convenience, the length of each of the thermally conductive fibers 22 is not less than 0.1 mm. In this embodiment, the length of each of the thermally conductive fibers 22 is not less than 0.1 mm and the thermally conductive fibers 22 are the graphitized vapor grown carbon fiber with a thermal conductivity not less than 1800 W/m·K.

If the liquid matrix is formed by heating, the same may be solidified by cooling. If the liquid matrix is formed by dissolving the base material in the viscosity modifier incapable of reacting with the base material, the same may be solidified by heating to remove such viscosity modifier. If the viscosity modifier is one capable of reacting with the base material, the solidifying step may be performed by reacting the base material with the viscositymodifier at room temperature or at an elevated temperature for a predetermined period.

It should be noted that a part of the support member 21 may be removed to increase the exposed area of the thermally conductive fibers 22, thereby improving heat dissipation capability of the heat dissipation element 2. For example, a part of the support member 21 may be removed from the bottom surface 211 thereof for exposing the thermally conductive fibers 22 from the bottom surface 211. Alternatively, the support member 21 may be hollowed out to form dips or holes therein to expose the thermally conductive fibers 22. The removal of apart of the support member 21 may be performed using laser, sandblasting, etc.

In FIG. 1, the electronic device 100 has a flat surface to which the heat dissipation element 2 is connected. However, it is worth mentioning that the electronic device 100 may have a curved surface or an uneven surface. The heat dissipation element 2 can have a shape that can be fittingly connected to the curved/uneven surface of the electronic device 100.

To sum up, by virtue of controlling the viscosity of the matrix and dipping the thermally conductive fibers 22 into the matrix to partially expose the thermally conductive fibers 22 from the matrix, the method for making the heat dissipation element 2 can be simplified. The heat dissipation element 2 thus obtained exhibits superior heat dissipation property.

While the disclosure has been described in connection with what are considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for making a heat dissipation element, comprising:
preparing a liquid matrix having a viscosity ranging from 1000 cps to 30000 cps;
dipping a plurality of thermally conductive fibers into the liquid matrix and having the thermally conductive fibers partially exposed from the liquid matrix; and
solidifying the liquid matrix into a support member from which the thermally conductive fibers are partially exposed.

2. The method as claimed in claim 1, wherein the matrix is made of a composition including a base material selected from the group consisting of a polymer material, a metal material, and an alloy material.

3. The method as claimed in claim 2, wherein the base material is selected from the group consisting of a phenol formaldehyde resin, a furan resin, an epoxy resin, a silicone resin, and a polyurethane resin.

4. The method as claimed in claim 3, wherein the composition of the matrix further includes a viscosity modifier.

5. The method as claimed in claim 4, wherein the base material is the epoxy resin.

6. method as claimed in claim 5, wherein the viscosity modifier is capable of reacting with the epoxy resin and is selected from the group consisting of n-butyl glycidyl ether, 1,4-butanediol diglycidyl ether, ethylene glycol diglycidyl ether, phenyl glycidyl ether, polypropylene glycol diglycidyl ether, C₁₂-C_{1,4} aliphatic glycidyl ether, benzyl glycidyl ether, 1,6-hexanediol diglycidyl ether, o-cresyl glicidyl ether, and neopentyl glycol diglycidyl ether.

7. The method as claimed in claim 5, wherein the viscosity modifier is incapable of reacting with the epoxy resin and is selected from the group consisting of acetone, anhydrous ethanol, toluene, xylene, styrene, ethyl acetate, butyl acetate, dimethylformamide, benzyl alcohol, and polyol.

8. The method as claimed in claim 2, wherein the metal of the base material is selected from the group consisting of silver, aluminum, copper, zinc, antimony and an aluminum alloy.

9. The method as claimed in claim 1, wherein the thermally conductive fibers are selected from the group consisting of metal fiber, carbon fiber, and the combination thereof.

10. The method as claimed in claim 9, wherein the carbon fiber is a graphitized vapor grown carbon fiber.
